(19) United States
(12) Patent Application Publication
(10) Pub. No.: US 2025/0296411 A1
(43) Pub. Date: Sep. 25, 2025

(54) Variable Transparency Glass System

(71) Applicant: Carver Lutz, New York, NY (US)

(72) Inventor: Carver Lutz, New York, NY (US)

(21) Appl. No.: 19/083,346

(22) Filed: Mar. 18, 2025

Related U.S. Application Data
(60) Provisional application No. 63/567,017, filed on Mar. 19, 2024.

(51) Int. Cl. B60J 3/04; B60R 16/033; G02F 1/01; G02F 1/1334; G02F 1/1514; G02F 1/169

(52) U.S. Cl. CPC B60J 3/04; G02F 1/0121; G02F 1/1334; G02F 1/1514; G02F 1/169; B60R 16/033

(57) ABSTRACT

A variable transparency glass system includes a transparent material; a variable transparency material that varies between transparent and opaque states responsive to an electrical signal; primary and secondary power sources electrically connected to the variable transparency material to switchably deliver respective primary and secondary electrical signals to the variable transparency material; and a controller. The controller monitors the output voltage of the primary power source switches from the primary electrical signal to the secondary electrical signal when the output voltage of the primary power source falls below a cutoff threshold. The variable transparency material may include a polymer-dispersed liquid crystal (PDLC) film, an electrochromic material, and/or a suspended particle device and may be applied to a surface of the transparent material (e.g., as in smart film) or laminated between layers of transparent material (e.g., as in smart glass).

### CROSS-REFERENCE TO RELATED APPLICATIONS

This application claims the benefit of U.S. provisional application No. 63/567,017, filed 19 Mar. 2024, which is hereby incorporated by reference as though fully set forth herein.

### FIELD

The present disclosure relates generally to switchable or variable transparencies, such as windows and other glass panels. In particular, the present disclosure relates to variable transparencies for use in vehicular applications, and, more particularly, as automobile windshields.

### BACKGROUND

Switchable glass (sometimes also known as smart glass) is a type of glass that can change its optical properties, varying between transparent, on one hand, and opaque or tinted, on the other hand, in response to electrical or thermal signals. Switchable glass is used, for example, as a substitute for window coverings to reject light and heat from entering a building.

In order to maintain a comfortable internal temperature, owners of vehicles similarly may find it desirable to reject light and heat from entering their vehicles when parked outside. Extant solutions include reflective and cardboard window screens, but such screens are disadvantageous insofar as they must be manually deployed for use and manually stowed between uses.

Switchable glass would mitigate these shortcomings. Switchable glass, however, has seen minimal uptake in the automotive industry, particularly with respect to front and rear windshields.

### BRIEF SUMMARY

The instant disclosure provides a variable transparency glass system including: a transparent material; a variable transparency material operable to vary between a transparent state and an opaque state responsive to an applied electrical signal; a primary power source electrically connected to the variable transparency material to switchably deliver a primary electrical signal to the variable transparency material; a secondary power source electrically connected to the variable transparency material to switchably deliver a secondary electrical signal to the variable transparency material; and a controller operably coupled to the variable transparency material, the primary power source, and the secondary power source. The controller is configured to: monitor an output voltage of the primary power source during delivery of the primary electrical signal to the variable transparency material; and when the output voltage of the primary power source falls below a cutoff threshold, switch from delivery of the primary electrical signal to the variable transparency material to delivery of the secondary electrical signal to the variable transparency material.

The variable transparency material can include a polymer-dispersed liquid crystal (PDLC) film, an electrochromic material, and/or a suspended particle device.

The controller may further be configured to regulate the electrical signal applied to the variable transparency material to maintain the variable transparency material at a preset transparency value.

It is also contemplated that the system may include a tertiary power source, such as a capacitor or supercapacitor, electrically connected to the variable transparency material to switchably deliver a tertiary electrical signal to the variable transparency material. Accordingly, the controller may be further configured to switch to delivery of the tertiary electrical signal to the variable transparency material when neither the primary electrical signal nor the secondary electrical signal is sufficient to maintain the variable transparency material at the preset transparency value.

The variable transparency material may be in the opaque state in absence of the applied electrical signal.

The primary power source may be a primary vehicle battery (e.g., a starter battery). The secondary power source may be a secondary vehicle battery (e.g., an auxiliary or accessory battery).

The controller may include a single-board computer.

The variable transparency material may be adhesively applied to a surface of the transparent material. Alternatively, the transparent material may include a first transparent panel and a second transparent panel and the variable transparency material may be sandwiched between the first and second transparent panels.

Also disclosed herein is a variable transparency system for vehicular glass. The variable transparency system includes: a variable transparency material operable to vary between a transparent state and an opaque state responsive to an applied electrical signal; and a controller operably coupled to the variable transparency film. The controller is configured to: monitor an output voltage of a primary power source during delivery of a primary electrical signal from the primary power source to the variable transparency material; and when the output voltage of the primary power source falls below a cutoff threshold, switch from delivery of the primary electrical signal to the variable transparency material to delivery of a secondary electrical signal from a secondary power source to the variable transparency material.

The variable transparency material may include a polymer-dispersed liquid crystal (PDLC) film, an electrochromic material, and/or a suspended particle device.

The controller may be further configured to regulate the electrical signal applied to the variable transparency material to maintain the variable transparency layer at a preset transparency value. The controller may be further configured to switch to delivery of a tertiary electrical signal from a tertiary power source to the variable transparency layer when neither the primary electrical signal nor the secondary electrical signal is sufficient to maintain the variable transparency material at the preset transparency value.

It is contemplated that the variable transparency material may be in the opaque state in absence of the applied electrical signal.

The controller may include a single-board computer.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a representative automobile.

FIG. 2 is a block diagram of a variable transparency system according to aspects of the present disclosure.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

The instant disclosure provides a variable transparency system for use with transparent materials, such as glass. The term “variable transparency glass system” will be used herein to refer to the combination of a variable transparency system according to the present teachings with glass.

For purposes of illustration, aspects of the disclosure will be described with reference to the use of variable transparency systems with automotive glass, and, more particularly, with automobile front windshields. Those of ordinary skill in the art will understand, however, how to apply the teachings herein to good advantage in other contexts (e.g., to other automobile glass, to other vehicle glass, and to other transparent materials).

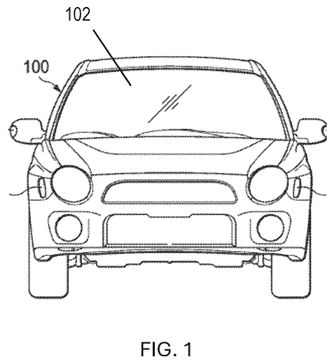

FIG. 1 depicts an automobile 100 including a windshield 102. As will be familiar to the reader, windshield 102 incorporates a transparent material. In typical automobile applications, this transparent material is laminated glass.

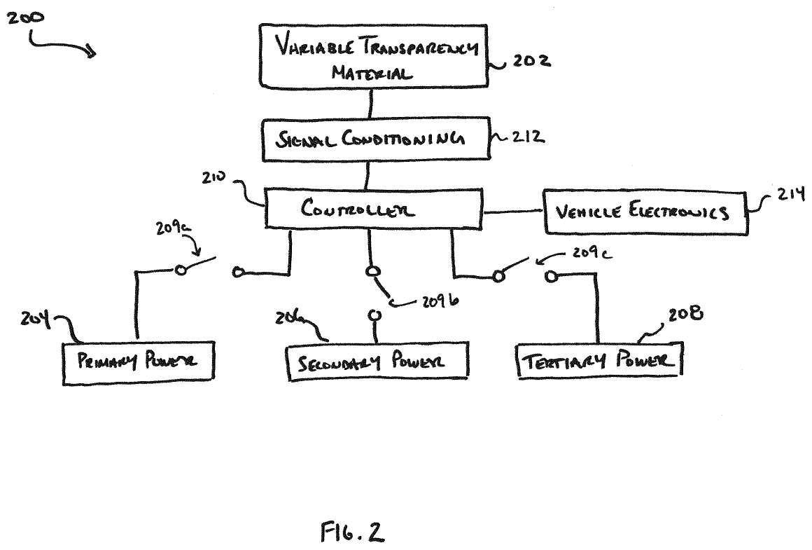

Windshield 102 further incorporates a variable transparency system. FIG. 2 provides a block diagram of an exemplary variable transparency system 200 according to aspects of the present disclosure.

Variable transparency system 200 includes a variable transparency material 202. The transparency of variable transparency material 202 varies between a transparent state and an opaque state in response to an electrical signal applied thereto. This variation may be discrete (e.g., fully transparent, on one hand, and fully opaque, on the other hand) or continuous (e.g., with varying degrees of transparency from fully transparent to fully opaque).

Variable transparency material 202 may be a polymer-dispersed liquid crystal (PDLC) film such as LCG® adhesive smart window films (Gauzy Ltd.; Tel Aviv, Israel). Other suitable variable transparency materials include electrochromic films (which advantageously enable continuous transparency variations) and suspended particle device (SPD) films.

The term “switchable film” will be used herein to refer to PDLC films, electrochromic films, SPD films, and other similar films that may be varied between a transparent state and an opaque state via application of an electrical signal. Further, though many extant switchable films that may be suitable for use as variable transparency material 202 are opaque in absence of an applied electrical signal (and an exemplary embodiment of variable transparency system 200 will be described herein as such), it is also within the scope of the present disclosure for variable transparency material 202 to be transparent in absence of an applied electrical signal instead.

A switchable film may be integrated into windshield 102 during manufacture, such as by sandwiching or laminating a layer of switchable film between the inner and outer glass layers of windshield 102 (e.g., as in the manufacture of switchable/smart glass). Alternatively, a switchable film may be applied to the surface of a standard windshield 102 after market (e.g., as in the application of smart film to otherwise ordinary glass). Both approaches (that is, both integral films and surface-applied films) will be familiar to those of ordinary skill in the art and thus need not be described further herein.

Variable transparency system 200 also includes a primary power source 204, a secondary power source 206. Primary power source 204 may be the primary (e.g., 12V starting) battery of automobile 100. Secondary power source 206 may be a secondary (e.g., auxiliary or accessory) battery of automobile 100; such batteries are often used to power various vehicle electronics, instead of the 12V starting battery, including as part of engine start-stop systems.

Optionally, automobile 100 may also include a tertiary power source 208, such as a capacitor, supercapacitor, or emergency power module. As discussed in further detail below, tertiary power source 208 can act as a fail-safe to maintain variable transparency material 202 in a transparent state while automobile 100 is in operation.

Each of primary power source 204, secondary power source 206, and optional tertiary power source are electrically connected to variable transparency material 202, through respective switches 209a, 209b, and 209c and a controller 210, to switchably deliver, respectively, a primary electrical signal, a secondary electrical signal, and a tertiary electrical signal to variable transparency material 202. Appropriate signal conditioning components 212, such as DC-DC converters, DC-AC inverters, transient voltage suppressors (e.g., TVS diodes), and the like, may also be provided to condition the input electrical signal to variable transparency material 202 (e.g., to provide an input electrical signal at the specified voltage and frequency for the chosen variable transparency material 202).

Controller 210 may be a single board computer (SBC) or microcontroller, such as the BeagleBone® Black Industrial single board computer (BeagleBoard.org; Michigan), the NVIDIA Jetson™ TX2i single board computer (NVIDIA Corporation; Santa Clara, California), or the NXP S32K automotive general-purpose microcontroller (NXP Semiconductors N.V.; Eindhoven, Netherlands) programmed with software and/or firmware to execute the functions and processes described herein.

Alternatively, controller 210 may be hardware-implemented, such as in an application specific integrated circuit (ASIC), field programmable gate array (FPGA), or solid state electronics.

Controller 210 may be operably coupled to vehicle electronics 214, including any infotainment system to permit user interaction with variable transparency system 200 (e.g., to adjust the transparency/opacity of variable transparency material 202 as discussed below) through a familiar user interface. In certain aspects of the disclosure, controller 210 may be attached to and communicate over the automobile 100 CANbus.

Controller 210 and/or signal conditioning components 212 may be housed in a protective enclosure suitable for automotive applications, such as a thermally-managed, automotive-rated enclosure to mitigate thermal damage and improve durability and longevity of variable transparency system 200. Automotive-grade wiring (e.g., TXL or GXL wire; shielded twisted-pair cables) and corresponding wiring layout practices (e.g., the use of heat-resistant looms or fiberglass sleeves for wires that are near heat sources; the use of insulated clamps to provide strain relief and secure mounting) may be used to interconnect the various components of variable transparency system 200. Insofar as those of ordinary skill in the art will be familiar with such practices, a detailed discussion thereof is not necessary herein.

As briefly mentioned above, in absence of an input electrical signal (e.g., with automobile 100 switched off), variable transparency material 202 will be opaque. Once automobile 100 is started, however, the primary electrical signal will be delivered from primary power source 204 to variable transparency material 202, rendering it transparent.

Controller 210 is configured to monitor the output voltage of primary power source 204. If the output voltage of primary power source 204 drops below a preset cutoff threshold (e.g., between about 12.7 V and about 13.0 V), however, controller 210 will switch to delivering the secondary electrical signal from secondary power source 206 to variable transparency material 202 (e.g., by closing switch 209b and opening switch 209a). Conversely, once the output voltage of primary power source 204 returns above a preset recovery threshold, which may be the same as or different from the preset cutoff threshold discussed above, then controller 210 will switch back to delivering the primary electrical signal from primary power source 204 to variable transparency material 202 (e.g., by closing switch 209a and opening switch 209a).

Controller 210 may also be configured to monitor and regulate the electrical signal (e.g., the primary electrical signal or secondary electrical signal) applied to variable transparency layer 202 to maintain variable transparency layer 202 at a preset transparency value. This preset transparency value may be full transparency or a fractional transparency (e.g., to tint windshield 102). As mentioned above, the preset transparency value may be user-adjustable, such as through a menu item in the user interface of the infotainment system for automobile 100, allowing the user to customize the degree of tint of windshield 102.

Tertiary power source 208 can provide a fail-safe to ensure that variable transparency layer 202 remains at the preset transparency value (such as full transparency) while automobile 100 is in operation (e.g., to ensure that variable transparency layer 202 does not lose power and return to its quiescent opaque state with automobile 100 in motion). Thus, for example, if controller 210 detects that neither the primary electrical signal from primary power source 204 nor the secondary electrical signal from secondary power source 206 is sufficient to maintain variable transparency layer 202 at the preset transparency value, it can switch to delivery of the tertiary electrical signal from tertiary power source 208 by closing switch 209c. As another example, if controller 210 detects that a signal conditioning component 212 (e.g., the DC-AC inverter) failure, it can switch to deliver of the tertiary electrical signal from tertiary power source 208 by closing switch 209c.

It is also contemplated that failures that result in the use of tertiary power source 208 may be accompanied by a warning to the operator of automobile 100, such as an audible warning (e.g., a warning chime) and/or a visual warning (e.g., a warning light or iconography in the instrument cluster or on the infotainment system display).

Although several embodiments have been described above with a certain degree of particularity, those skilled in the art could make numerous alterations to the disclosed embodiments without departing from the spirit or scope of this invention.

For example, controller 210 may also be configured to monitor temperature of variable transparency system 200 and reduce the voltage of the electrical signal delivered to variable transparency material 202 to prevent overheating.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A variable transparency glass system, comprising:
a transparent material;
a variable transparency material operable to vary between a transparent state and an opaque state responsive to an applied electrical signal;
a primary power source electrically connected to the variable transparency material to switchably deliver a primary electrical signal to the variable transparency material;
a secondary power source electrically connected to the variable transparency material to switchably deliver a secondary electrical signal to the variable transparency material; and
a controller operably coupled to the variable transparency material, the primary power source, and the secondary power source,
wherein the controller is configured to:
monitor an output voltage of the primary power source during delivery of the primary electrical signal to the variable transparency material; and
when the output voltage of the primary power source falls below a cutoff threshold, switch from delivery of the primary electrical signal to the variable transparency material to delivery of the secondary electrical signal to the variable transparency material.

2. The system according to claim 1, wherein the variable transparency material comprises a polymer-dispersed liquid crystal (PDLC) film.

3. The system according to claim 1, wherein the variable transparency material comprises an electrochromic material.

4. The system according to claim 1, wherein the variable transparency material comprises a suspended particle device.

5. The system according to claim 1, wherein the controller is further configured to regulate the electrical signal applied to the variable transparency material to maintain the variable transparency material at a preset transparency value.

6. The system according to claim 5, further comprising a tertiary power source electrically connected to the variable transparency material to switchably deliver a tertiary electrical signal to the variable transparency material, and wherein the controller is further configured to switch to delivery of the tertiary electrical signal to the variable transparency material when neither the primary electrical signal nor the secondary electrical signal is sufficient to maintain the variable transparency material at the preset transparency value.

7. The system according to claim 6, wherein the tertiary power source comprises a capacitor.

8. The system according to claim 1, wherein the variable transparency material is in the opaque state in absence of the applied electrical signal.

9. The system according to claim 1, wherein the primary power source comprises a primary vehicle battery.

10. The system according to claim 1, wherein the secondary power source comprises a secondary vehicle battery.

11. The system according to claim 1, wherein the controller comprises a single-board computer.

12. The system according to claim 1, wherein the variable transparency material is adhesively applied to a surface of the transparent material.

13. The system according to claim 1, wherein the transparent material comprises a first transparent panel and a second transparent panel and wherein the variable transparency material is sandwiched between the first transparent panel and the second transparent panel.

14. A variable transparency system for vehicular glass, comprising:
a variable transparency material operable to vary between a transparent state and an opaque state responsive to an applied electrical signal; and
a controller operably coupled to the variable transparency film,
wherein the controller is configured to:
monitor an output voltage of a primary power source during delivery of a primary electrical signal from the primary power source to the variable transparency material; and
when the output voltage of the primary power source falls below a cutoff threshold, switch from delivery of the primary electrical signal to the variable transparency material to delivery of a secondary electrical signal from a secondary power source to the variable transparency material.

15. The system according to claim 14, wherein the variable transparency material comprises a polymer-dispersed liquid crystal (PDLC) film.

16. The system according to claim 14, wherein the variable transparency material comprises an electrochromic material.

17. The system according to claim 14, wherein the variable transparency material comprises a suspended particle device.

18. The system according to claim 14, wherein the controller is further configured to regulate the electrical signal applied to the variable transparency material to maintain the variable transparency layer at a preset transparency value.

19. The system according to claim 18, wherein the controller is further configured to switch to delivery of a tertiary electrical signal from a tertiary power source to the variable transparency layer when neither the primary electrical signal nor the secondary electrical signal is sufficient to maintain the variable transparency material at the preset transparency value.

20. The system according to claim 14, wherein the variable transparency material is in the opaque state in absence of the applied electrical signal.

21. The system according to claim 14, wherein the controller comprises a single-board computer.
